(19) United States
(12) Patent Application Publication
(10) Pub. No.: US 2004/0017347 A1
(43) Pub. Date: Jan. 29, 2004

(54) Method for fabricating color pixels without light filters

(76) Inventors: Gareth G. Hougham, Ossining, NY (US); Christos Dimitrios Dimitrakopoulos, Ossining, NY (US); Shui-Chih Alan Lien, Briarcliff Manor, NY (US)

Correspondence Address: JANIK MARCOVICI, Perman & Green, LLP, 425 Post Road, Fairfield, CT, 06430, US

(21) Appl. No.: 10/207,617

(22) Filed: Jul. 29, 2002

(51) Int. Cl. G09G 3/36; G09G 5/00

(52) U.S. Cl. 345/88; 345/102; 345/211

(57) ABSTRACT

An electrically selectable diffraction grating made of electrodes that can fabricate color pixels of light from a full spectrum of light or a white light with the particular color being based on the spacing sequence of the energized electrodes. In an unaltered state the electrodes are transparent to light, once energized the electrodes become opaque to light. A full spectrum of light can be diffracted into individual wavelengths of colored light when passed through the transparent spaces provided by the unenergized electrodes.

### BACKGROUND OF THE INVENTION

1. Field of The Invention

This invention is an electrical device with an optical element; the invention relates specifically to the fabrication of color pixels with an electrically selectable diffraction grating spacing.

2. Brief Description of Related Developments

The standard method of creating color flat panel displays involves the use of optical filters. In a typical example, each pixel of the display is subdivided into three subpixels, which are independently addressable. Each of the subpixels consist of a liquid crystal light valve (cell), which can allow passage or block passage of light coming from a light source. Between the subpixel cell and the viewer's eye is a color filter. Typically, in a full pixel one subpixel has a red filter, one has a green filter, and one has a blue filter.

The standard method has the drawback that from the area associated with one full pixel, only one subpixel allows light passage, therefore cutting the light to ⅓ its possible value. When white light impinges on the filter and only ⅓ is allowed to pass, the other ⅔ of the spectrum becomes absorbed. Thus, brightness is compromised for a given output of light from the light source. This compromise requires more power consumption than would be necessary if a more efficient use of light were possible. A further disadvantage of color filters is that they are expensive to manufacture requiring multiple lithographic steps. A still further disadvantage is that the dyes and pigments can act as sources of contamination to the liquid crystal in cases where direct contact is made.

A method and apparatus has been discovered to fabricate color pixels without color filters. The present invention may result in greater efficiency in the use of light than offered by the prior art, and the invention obviates the use of dyes and pigments, which may contaminate the liquid crystal as aforementioned.

### SUMMARY OF THE INVENTION

The present invention is both an apparatus and method for fabricating color pixels with electrically selectable diffraction gratings.

In accordance with one embodiment an electrically selectable grating is connected to a power source. A light is emitted through the energized grating for diffraction spatially separating the spectrum and allowing passage of a predetermined color of light.

In accordance with another embodiment the electrically selectable diffraction grating connected to a power source is immersed in an electrically active fluid contained inside a transparent casing. An opaque barrier having an opening is positioned above the contained grating. The grating is energized and a light is emitted into the bottom of the casing and exits the top of the casing as diffracted wavelengths for selection by the opening as a specific color.

In accordance with another embodiment an electrically selectable diffraction grating is placed below a smooth solid barrier that has a reflective coating on the bottom side. The barrier has an opening. Placed below the grating is a reflective device such as a mirror having substantially the same length as the grating. When the grating is energized a light source between the grating and the reflective device emits light up through the grating. The light is diffracted with one selected wavelength passing through the opening and into a human eye. The unselected wavelengths are reflected back down through the grating to the reflective device and again back up through the grating for possible reselection.

In accordance with another embodiment of the invention at least two electrically selectable diffraction gratings are used with one being positioned in vertical alignment above the other, each having a different sequence of electrodes connected to a power source. When unenergized, the grating being transparent to light so that light will pass through it unaltered or undiffracted. One grating is energized based on a preselected sequence of electrodes to have a specific color of light and a light is emitted into the lowest grating with it passing out the top of the highest grating in the form of a specific color of light. The variety of color being selected according to the grating energized.

### BRIEF DESCRIPTION OF THE DRAWINGS

FIG. 1 is a top view of a pixel having three sub pixel width diffraction gratings;

FIG. 2A is a profile view of one grating and associated main cell elements using twisted nematic without electric activation.

FIG. 2B is a profile view of one grating and associated main cell elements using twisted nematic with electric activation.

FIGS. 3A-3F show both top views and profile views of electrically switchable gratings placed below a fixed optical slit with example patterns for selection of different colors;

FIGS. 4A-4B is a top and a profile view respectively of an embodiment that reflects unselected wavelengths back to a pool of sourcelight for efficiency purposes;

FIGS. 5A-5B are top and profile views of cells utilizing a side light source;

FIGS. 6A-6C illustrate a cell type where a fixed grating is used in combination with an electrically selectable optical slit to produce different colors;

FIG. 7 is another embodiment of the invention using a single grating that can be switched between several different states to diffract impinging light to different angles to produce different colors;

FIG. 8 shows a schematic view of a novel thin film transistor (TFT) to a design used to empower indium tin oxide (ITO) strips to produce a single color of light;

FIG. 9 is a schematic view of a pixel in accordance with yet another embodiment of the present invention; and

FIG. 10 shows a schematic view of a conventional thin film transistor (TFT).

### DETAILED DESCRIPTION OF THE INVENTION

Selectable Diffraction Gratings.

Described herein are structures, which facilitate the modulation of light and the selection of certain wavelength ranges of light by use of diffraction gratings. Diffraction gratings are arrays of equally or parallel spaced slits that diffract or interfere with a large number or continuous distribution of wave sources. The diffraction method described herein is the diffraction of rays that are selected by transparent electrodes to offer color light without the use of light filters.

The invention may find application in a wide variety of technical applications, however, more typically, the invention is used as a flat panel or liquid crystal display. Technical applications include a broad range of electronic displays: pseudoanalog, alphanumeric, vectorgraphic, and video. Examples of pseudoanalog applications are: meterlike presentations, go/no-go messages, legends and alerts, analoglike (watch) dials. Examples of alphanumeric applications are: digital watches, calculators, digital multimeters, message terminals, and games. Examples of vectorgraphic applications are: computer terminals, TWX terminals, airport arrival and departure screens, scheduling terminals, weather radar, air-traffic control and games. Examples of video applications are: entertainment television, graphic arts, video repeaters, medical electronics, aircraft flight instruments, computer terminals, command and control and games. In alternate embodiments, the invention may find application in optical switching such as for communication networks, wavelength division and multiplexing, monochromators or otherwise.

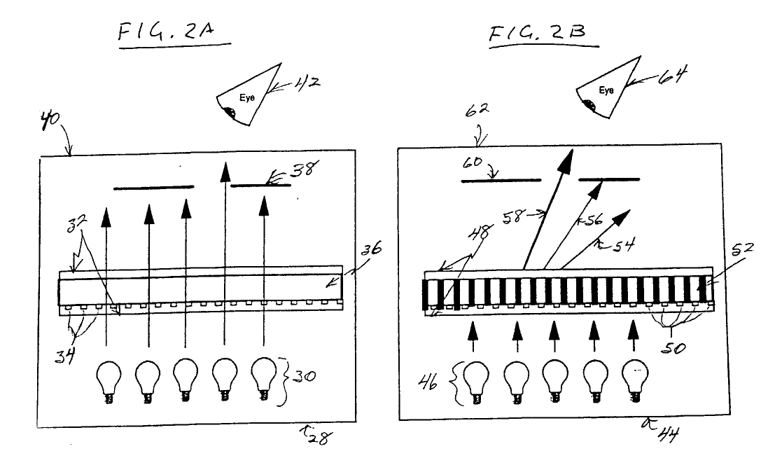

In some embodiments of the present invention, the difference in refractive index alone between an oriented and an unoriented liquid crystal 52 would provide adequate diffraction, and thus eliminate the need for polarizing film layers currently in use, further improving the light throughput (FIG. 2B). In other embodiments, the selectable gratings may provide advantages for projection displays, rather than flat panel displays.

The basic concept disclosed herein is that a white light or a full spectrum of visible light emitting parallel rays is diffracted into separate wavelengths having chromatic attributes or hues such as red, yellow, green, blue etc.

All visible light is electromagnetic radiation in the wavelength region of 400-700 nm, which is the range of vision perceptible to the human eye. Within the 300 nm range, herein referred to as white light, there are thousands of wavelengths of light.

The hue is recognized by the strength of the chromatic responses. The purpose of the diffraction gratings disclosed herein is to separate white light or full spectrum light, emitted in parallel rays, into separate wavelengths having chromatic attributes or hues such as red, yellow, green, blue, etc. without filtering. The gratings allow the user to control the hue or color that exits the remainder of the cell by the sequence of spacing of the electrodes 18.1 through 18.n, 20.1 through 20.n and 21.1 through 21.n. The distance between the electrodes that become opaque upon being energized controls the respective angle of a given wavelength of the light ray that exits the gratings. The remainder of the cell allows discriminating which wavelength gets to pass through the remainder of the cell to the observers eye.

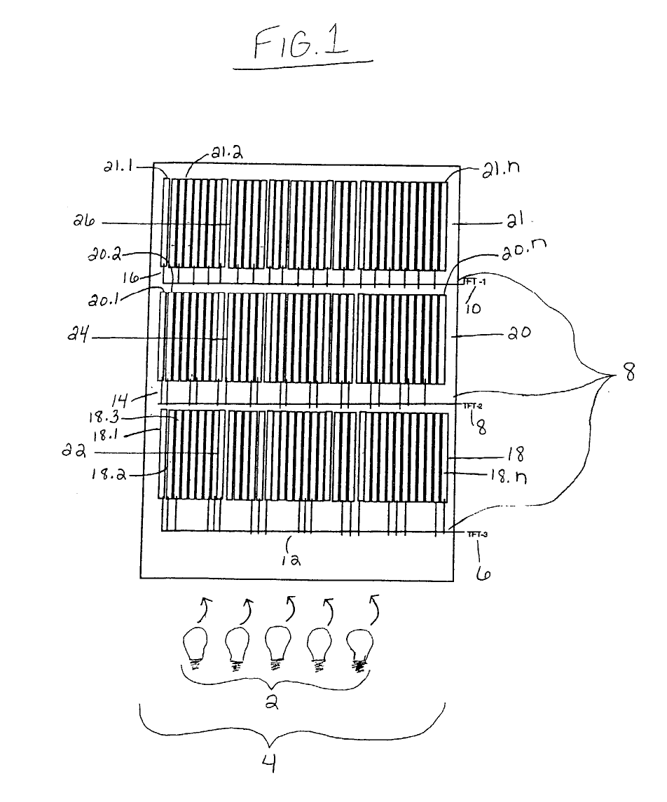

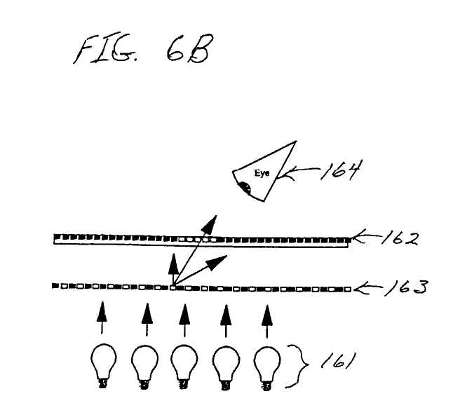

FIG. 1 shows a top view of a full pixel 4 having three sub pixel width diffraction gratings 18, 20 and 21, each in the same horizontal plane and each wired to activate a different pattern of lines. In alternate embodiments, gratings 18, 20 and 21 may be in different planes or may be stacked one over another as will be described further below. The pixel 4 width array is configured into gratings 18, 20 and 21, each having thin strips 18.1-18.n, 20.1-20.n and 21.1-21.n of transparent electrode material, such as indium tin oxide (ITO). In alternate embodiments more or less gratings or strips may be used. A wide variety of materials may be used to form the electrodes such as silver, nickel, zinc, cadmium or gallium. In alternate embodiments, other suitable materials may be used. In cases such as shown in FIG. 5A and 5B, the light may pass through a conducting transparent electrode and reflect off a mirror surface from the back (e.g. assume the indium tin oxide is on reflective metal), but, FIGS. 5A and 5B could also be functional without indium tin oxide, having only the mirror metal itself, such as for example, requiring reflective metal. The electrodes may have any shape, so long as it will diffract light, including circles, triangles, squares or otherwise.

The dimensions of the entire grating 18, 20, 21 might be in the range of 100 um long by 50 um wide and with each grating having a top and a bottom. However, the grating may have any dimension as long as it will diffract light. Each ITO strip 1 might be on the order of 5 um wide and 50 um long. The narrower the strips 18.1-18.n, 20.1-20.n and 21.1-21.n the better the resulting wavelength resolution, however the narrower, the strips 18.1-18.n, 20.1-20.n and 21.1-21.n the more expensive the photolithography methods required. The space between each ITO strip 18.1-18.n, 20.1-20.n and 21.1-21.n is minimal to ensure that no electrical shorting takes place.

To each array or grating in FIG. 1 groups of wiring 12, 14, 16 are affixed. Each wiring group 12,14,16 corresponds to a desired color. In this invention the term color is defined to mean any wavelength of light that can be distinguished from any other wavelength of light by the human eye. For instance, as a conceptual example, to emit color one, every other strip would be electrically connected and energized. So, for example, if the strips 21.1-21.n were 5 um wide each, this would result in a grating with a 5 um alternation of transparent and opaque rectangles when energized. The grating would diffract or refract in a defined and reproducible manner. As a result, the structure in FIG. 1 may be viewed as a full pixel 4 with three subpixels, each controlling a different color, for example one of the primary colors red green or blue. For example, subpixel grating 21 could give red, subpixel grating 20 could give green and subpixel grating 18 could give blue. If red is desired of the full pixel 4, then subpixel 21 would be energized and subpixels 20 and 18 would remain unenergized allowing all wavelengths to pass. If blue is desired of the full pixel 4, then subpixel 18 would be energized and subpixels 20 and 21 would remain unenergized allowing all wavelengths to pass. If green is desired of the full pixel 4, then subpixel 20 would be energized and subpixels 21 and 18 would remain unenergized allowing all wavelengths to pass.

The electrical power for the invention may come from a wide variety of sources. It may be AC or DC; it may come from a battery, color panel or any other source of electrical power.

The thin film transistors (TFT's) 6, 8, 10, which control the selection of strips to be powered, transmit power to a single group of wiring respectively (e.g. 12, 14, 16). This is important as it keeps each line electrically isolated from each other line. In the embodiment of FIG. 1, each of the three gratings 18, 20, 21 is controlled by a separate TFT. Within each of the subpixel gratings 18, 20, 21 the strips predetermined as activatable are shorted to each other and connected to their respective TFT 6, 8, 10, via their respective wiring group 12, 14, 16. By contrast, in FIG. 7, each of the conductive strips is not shorted to the other conductive strips and has a unique path back to each TFT 66, 68, 70. Grayscale can be achieved by applying different voltages to the TFT's, which would change the diffraction efficiency.

FIG. 1 uses three different subpixel diffraction gratings 18, 20, and 21, one positioned next to the other, per pixel 4 where each subpixel would have different groupings of strips powered in patterns, sequences, or combinations that provide different selectable wavelengths of light. Herein, three diffraction colors will be discussed; however, the differences in patterns or sequences of strips 18.1-18.n, 20.1-20.n and 21.1-21.n are virtually limitless. Therefore, many thousands of colors or hues of light may be produced by the arrays or gratings. Each grating 18, 20, 21 has the capacity of switching between an energized or opaque state and a transparent state to provide an individual wavelength or color of light.

The operation of the switchable gratings of FIG. 1 is as follows:

In grating 20, every other strip 21.1, 21.3, 21.5 etc is connected to a power source through conductive wiring. Strips 21.1 through 21.n are transparent to light without being electrified and connected strips 21.1, 21.3, 21.5, etc becomes opaque to light upon being energized with the strips between them remaining transparent. Similarly, in grating 20, strips 20.1, 20.2, 20.5, 20.6, 20.9, 20.10 etc are connected in pattern with the strips in between being not connected in pattern. Similarly, in grating 18, strips 18.1, 18.2, 18.3, 18.7, 18.8, 18.9 18.13, 18.14, 18.15 etc are connected in pattern with the strips in between being not connected in pattern. Upon energizing, or selectively energizing the array or grating 18, 20, 21 energized used separates light into a specific wavelengths or hues of visible color.

When a light source 2 is placed under the plane of pixel 4 and produces white light in parallel rays through the bottom of the switchable gratings 18, 20, 21 they are considered transmissive gratings. In the alternative, when the light enters from the same side as the viewer the switchable gratings become reflective.

In using the switchable grating as a transmissive grating the TFT 6, the conductive wiring 12 and the diffraction grating 18 perform as a complete circuit 22 that receives power or voltage through the TFT 6 and defracts the light or does not receive power and is transparent.

Each diffraction grating circuit 22, 24, 26 is powered independently and not in unison to offer different wavelengths of light, which are visible as colors one, two and three respectively.

In order to produce a color to the visible eye the wires 12, 14, 16 are connected to individual indium tin oxide (ITO) strips 18.1-18.n, 20.1-20.n and 21.1-21.n that constitute the diffraction grating 18, 20, 21. For example, color three is produced by energizing the ITO strips 18.1, 18.2, 18.3 in a 3 on and the next 3 off sequence from power source TFT-3 6 through the conductive wires 12 to the individual ITO strips 18.1, 18.2, 18.3 connected to the wires 12 to complete the circuit 22. Simultaneously, the power to circuits 24 and 26 may be left off. Therefore, for color three, while the power to circuit 22 is on, the power to circuits 24 and 26 may be left off. To produce color two, likewise while the power to 24 is on, the power to circuit 22 and 26 may be left off; and lastly, while the power to circuit 26 is on, the power to circuits 22 and 24 may be off to produce color one. As previously discussed there is no known limit to the number of electrode 18.1-18.n, 20.1-20.n and 21.121.n sequences in gratings or the number of hues or colors of light that can be produced.

When circuit 24 is energized two ITO strips 20.1, 20.2 are on and the next two ITO strips are off in sequence to produce color two, and when circuit 26 is energized one ITO strip 21.1 is on and the next ITO strip is off in sequence to produce color one.

Turning now to the second embodiment of the invention, liquid crystals are known to have many applications. They are used as displays in digital wristwatches, calculators, panel meters, and industrial products. They can be used to record, store, and display images, which can be projected onto a large screen. Direct and active-matrix liquid-crystal displays (LCD's) can be used as displays in several areas ranging over office automation equipment such as laptop computers to communication equipment such as television teleconferencing systems, portable and high-definition television (HDTV), and video games.

The two features that make liquid crystals more desirable for displays than other material are lower power consumption and the clarity of display in the presence of bright light. The power requirements are often so low that a digital display on a wristwatch requires about the same power, as does the mechanism that runs the watch. The two modes most widely used in liquid-crystal displays are dynamic-scattering and field-effect. The present invention does may be applied for use with multiple light value types, for example from nematic liquid crystal to electrochromic or otherwise.

In displays, the liquid-crystal cell design usually begins with a thin film of a room-temperature liquid crystal sandwiched between two transparent electrodes (glass coated with a metal or metal oxide film) . The thickness of the liquid crystal film is 6-25 micrometers and is controlled by a spacer, which is chemically inert. The cell is hermetically sealed in order to eliminate oxygen and moisture, both of which may chemically attack the liquid crystalline material.

In one embodiment of the present invention a subpixel consists of a LC cell made in the lower surface (below the LC alignment layer) that occupies the volume of the cell with transparent electrodes forming the top inner surface of the cell.

Before any power is supplied to the LC cell, the LC allows passage of light through all strips FIG. 2A. Upon closing the circuit 22 or 24 or 26 a fraction of the strips 18.1-18.n, 20.1-20.n and 21.1-21.n will form one pole of a capacitor and the resulting electric field in that confined space will disrupt the LC order and block the light. Thus, a repeating pattern of transparent and opaque strips will have been formed, and the impinging white light will undergo interference, which is wavelength dependent. This will have the effect of spatially separating the different colors of light 54, 56, 58 on the exiting side of the cell.

FIG. 2A illustrates the design of a cholesteric-nematic structure or twisted nematic such as cholesteric ester. The first outer casing 28 may or may not be constructed of a transparent substance. The light source 30 emits wavelengths of light, through a transparent substrate 32, into a grating with ITO strips 34 not energized, into a transparent inner casing 36 that holds an electrically active fluid and the ITO strips 34. Both the inner casing 36 and outer casing 40 each have a respective top side and bottom side. The wavelength light is unaffected as it passes out of the inner casing 36, through an solid barrier 38 with an optical slit or opening, through second outer casing 40, and into the human eye 42. To accomplish the aforesaid result the human eye is above the outer casing 40, outer casing 40 is above the barrier 38, the barrier 38, is above the inner casing 32, the inner casing 32 is above the light source 30, and the light source 30 is above the outer casing 40. When power is applied to the grating, the optical situation of FIG. 2B results.

Additional embodiments of FIG. 2A and FIG. 2B include the use of different electroactive fluids that can be used in combination with the gratings.

The first additional embodiment for FIG. 2A is an electrochromic type cell 36 unpowered or 52 powered comprised of an electroplatable metal salt in electrolyte solution. In this embodiment, the energized bismuth chloride eletroplates the ITO strips 50 to diffract light. Other examples of electroplatable metal salts in electrolyte solutions are: antimony sulfides, cadmium sulfates, nickel, copper, tungsten and chromium sulfates in addition to many other types. After the power is switched off, the bismuth chloride is stable until an opposite potential is applied. This first additional embodiment offers bi-stable cells with power savings.

FIGS. 2A and 2B will apply whether a liquid crystal is used or an electrochromic, except that L.C. polarizing sheet layer(s) are needed (not shown).

The second additional embodiment for FIG. 2A is the use of an IPS/LCD (In plane switching type liquid crystal) material for the electrically active fluid.

FIG. 2B illustrates the same cell as FIG. 2A but after power has been applied. An outer casing, 44 that may or may not be constructed of a transparent material, contains a light source 46. The light emitted from the light source passes through a transparent substrate 48, which comprises an inner casing 52 that holds an electrically active substance and a diffraction grating wired the same as unit 26 in FIG. 1.

The light then passes out of the transparent substrate 48 as colors three 54, two 56 and one 58 respectively. Selected color one passes through the optical slit 60 and through the transparent outer casing 62 and into the human eye 64.

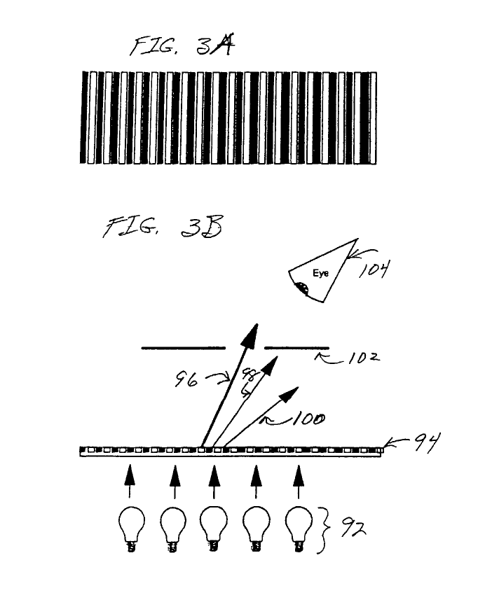

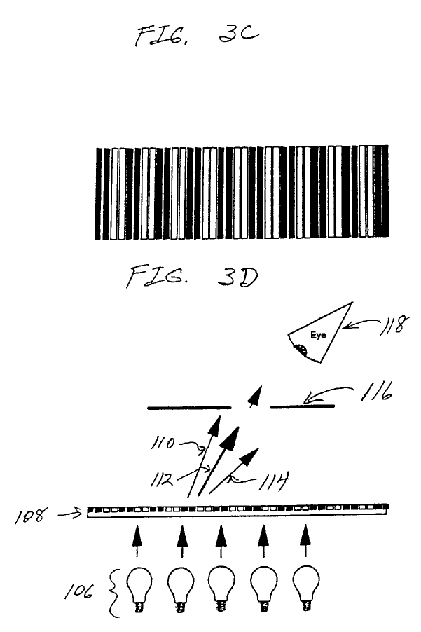

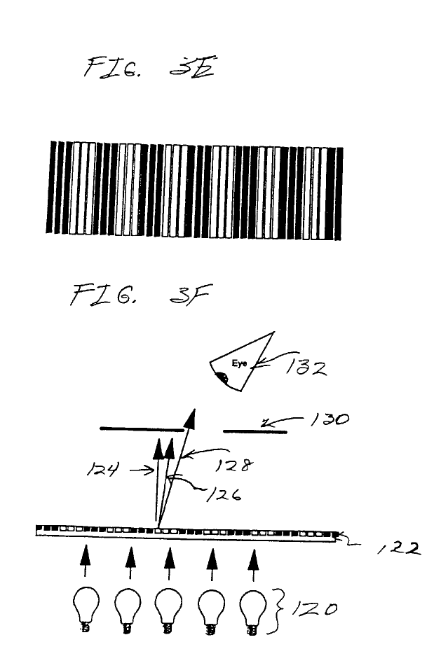

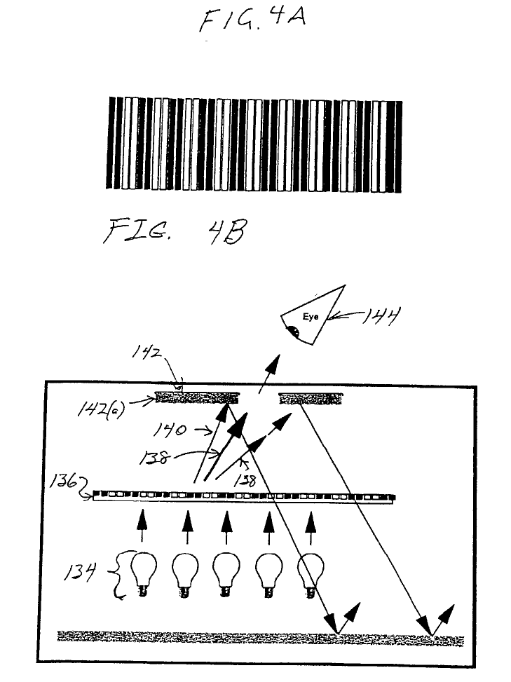

FIGS. 3A-3F show both top views and profile views of electrically switchable gratings placed below a fixed optical slit with example patterns for selection of different colors such as for example, a primary color red, green and blue, the colors being represented by three arrows respectively in each view.

FIG. 3B shows the emission of color one to the human eye 104 of the diffraction grating depicted in FIG. 3A. Where the light source 92 emits light through the grating 94 having the sequence of one ITO strip on and one ITO strip off to produce color one 96 that is seen in the receiver's eye 104 through the optical slit 102 while colors two and three do not reach the receiver's eyes 104.

FIG. 3D illustrates the light source 106 emitting light through a grating having the ITO strip sequence of two on and two off to produce color two 112 that passes through the optical slit 116 to the human eye 118. FIG. 3C represents the electrode sequence that produces color two.

FIG. 3F illustrates a light source 120 emitting light through a grating 122 having the sequence of three ITO strips on and three ITO strips off to produce color three 128 that passes through the optical slit 130 to the human eye 132. FIG. 3E represents the electrode sequence that produces color three.

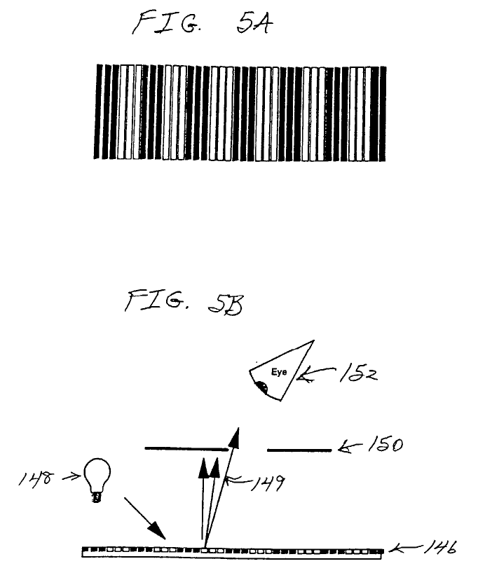

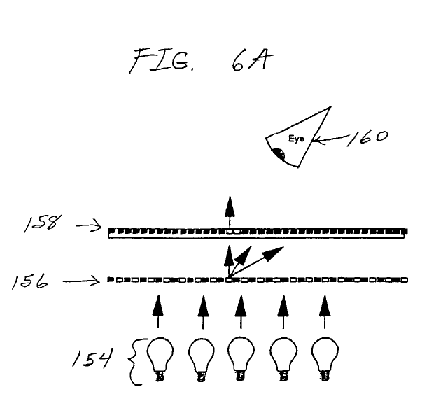

One drawback of the main embodiment is the loss of approximately ⅔ of the emitted light. The embodiment illustrated in FIGS. 4A and 4B reduces the amount of lost emitted light. A light source 134 emits white light through a grating 136 having two ITO strips on and two ITO strips off such that the selected light or color two 140 passes through a smooth solid barrier 142 with a reflective coating 142(a), the barrier 142 having an the optical slit or opening 142, to the human eye 144, and the unselected colors 138(b) and 140 are reflected by a first mirror layer 142(a) back through the grating 136 to a second mirror 146 in order to reenter the grating 136 for selection through an additional optical slit. In order to produce the hue of color, the human eye 144 looks down into the opening in the smooth solid barrier 142 with a reflective coating 142(a) such as a mirror layer positioned on the bottom side of the barrier 142 above the diffractive grating 136 that is above the light source 134 with the light source 134 above the reflective device 146 or mirror.

A reflective embodiment of the selective grating concept is shown in FIGS. 5A and 5B. A side light source 148 emits light from above a grating 146 having three ITO strips on and a three ITO strips off sequence to produce the selected color 149 through the optical slit 150 into the human eye 152. FIG. 5A represents the electrode sequence that produces color three.

Selectable Optical Slits.

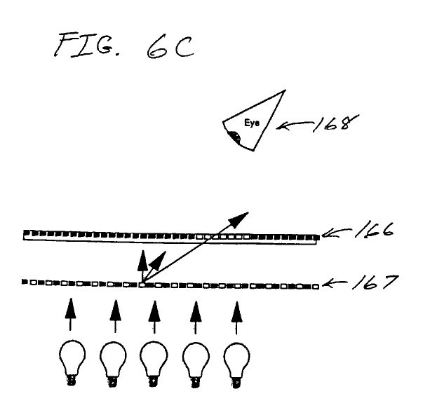

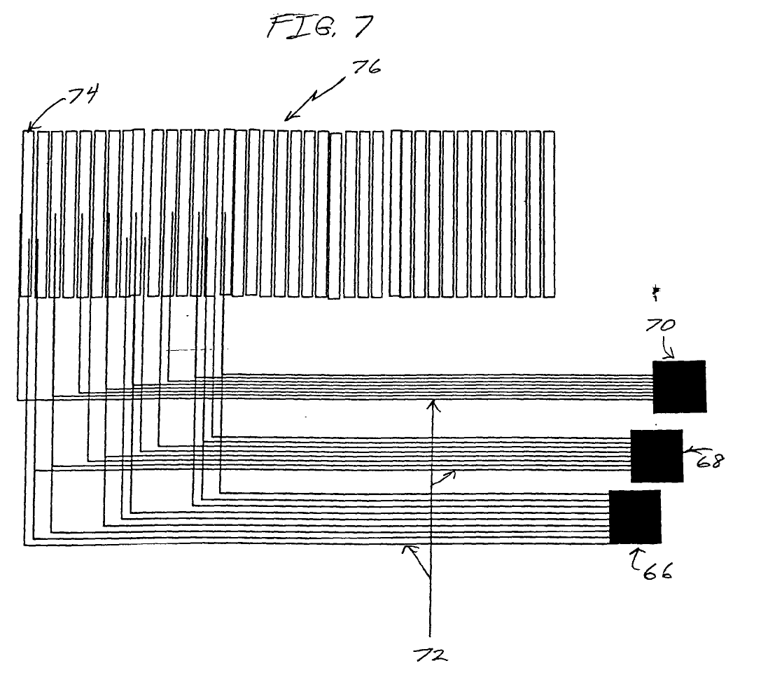

As an alternative to the selectable gratings, FIG. 6A for example, offers an embodiment to use a fixed grating 156, which would diffract or refract the light in the same way at all times, and simultaneously employ a selectable optical slit 158. This may have significant advantages in that the dimensions of the switchable component are much larger and would be more cost effective to fabricate. In this case the same principle for how to power three different groupings of strips operate. The optical slit element 158 would consist of an array 24 of ITO strips 9, 11, 13, with appropriate strip sequence groupings, wired to diffract a specific color of light.

In FIG. 6A the switchable optical slit operates as follows: A light source 154 emits light through a fixed grating 156. The light then strikes a series of ITO strips 158 that are energized in certain combinations to provide an electrically defined slit location to produce a selected color for the human eye 160. The selected color received by the human eye 160 being based on the positions of the switchable optical slit that could be changed to allow different colors to pass.

FIGS. 6B and 6C illustrate an electrically selectable optical slit 162 and 166 that operates in a similar method to the optical slit of FIG. 6A only having a different sequence of energized ITO strips 163 and 167 so that a different color selection passes to the human eye 164 and 168.

FIG. 7 is an additional embodiment of the present invention that requires only one grating per pixel instead of three subpixel gratings per pixel. This second embodiment could be placed in the same type of LC cells 36 and 52 as in FIGS. 2A and 2B.

In FIG. 7 the TFT's 66, 68, 70 may be individually energized and attached to the ITO strip 74 that form a single grating 76. The sequence of the wiring is as follows: TFT 66 is wired 72 to the ITO strips 74 in a three on and three off sequence, to produce color three. TFT 68 is wired 72 to the ITO strip 74 in a two on and two off sequence to produce color two; and TFT 70 is wired 72 to the ITO strip 74 in a one on and one off sequence to produce color one. Therefore, when the one respective TFT is energized the other TFT's are not energized, as described in FIG. 1, colors three, two and one can be emitted from the single grating 76.

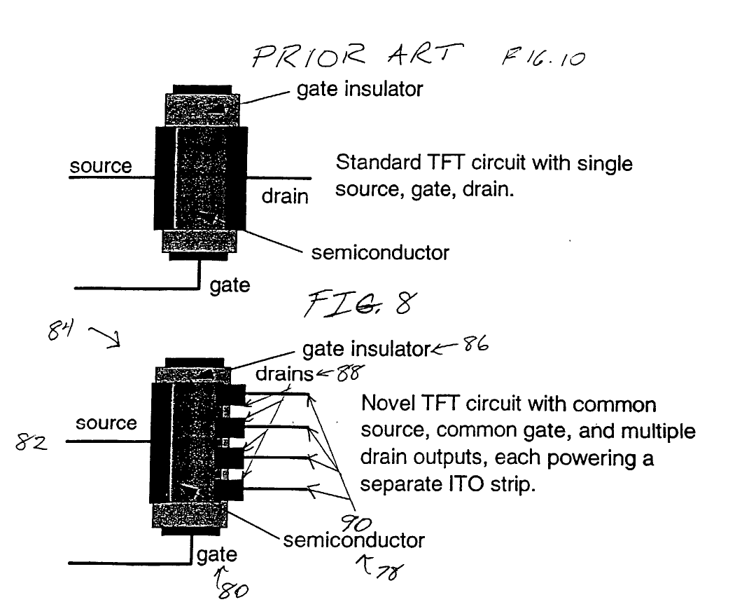

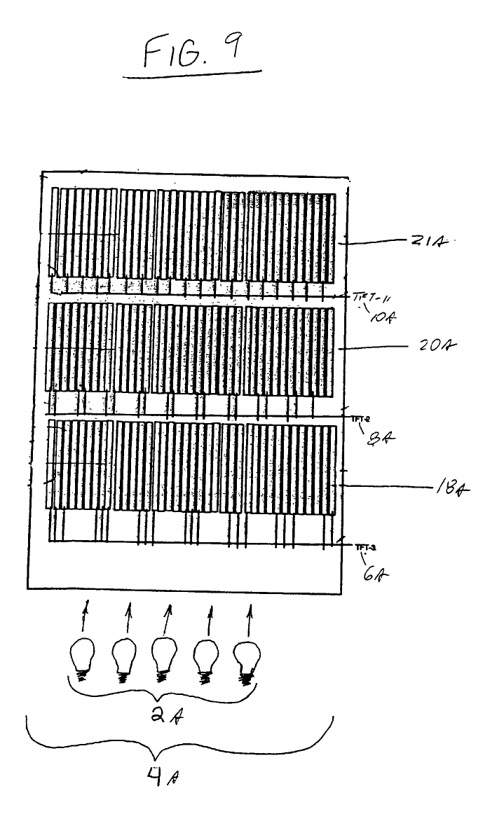

FIG. 8 shows a novel thin film transistor (TFT) used to empower indium tin oxide (ITO) strips to produce a single color of light. This prevents short circuits between drain outputs when a transistor is not activated and may be employed for selectable gratings as shown in FIG. 7. A special TFT 84 is used for a single pixel of the type shown in FIG. 7, single grating apparatus. A semiconductor 78 is housed inside a gate insulator 86 connected to a gate 80 of a power source 82 that conducts electricity through the semiconductor 78 into a multitude of drains 88 connected to conductive wires 90 that each power a separate ITO strip (not shown) The ITO strips are arranged in a single grating, (FIG. 7) or in multiple gratings (FIG. 1) sequentially in order to produce colors one, two, and three as described in FIG. 1. FIG. 10 shows a schematic view of a conventional. TFT for comparison purposes.

There are a variety of alternate embodiments to this invention. One embodiment includes employing the grating in a plane switching mode. The concept of switchable diffraction gratings and/or switchable optical slits can be applied to an in plane switching mode of liquid crystals cells. In IPS technology, the positive and negative poles in the LC cell are on adjacent ITO strips instead of being on opposing internal faces of the LC cell. The general advantages and characteristics of IPS mode are well understood in the art. However, the extension of IPS mode to switchable gratings and optical slits has not been described and the combination is particularly attractive.

The primary modification required to implement IPS is that in addition to addressing the ITO strips in appropriate groups with, for example, a positive potential with the negative supplied by the opposite face of the cell, now a single diffraction “grove” is made by powering two adjacent strips as positive and negative, and a strip next to that pair left to float at zero potential. This will create the desired alternation of transmissive and opaque regions needed for either diffraction grating or optical slits.

Another embodiment may be the use of the gratings as communication optical transducers or switches. These device types are useful in other applications besides flat panel displays. Anywhere that the modulation of light is required with wavelength selectivity. Even more generally, anywhere that spatial discrimination of light for transmission is required. For instance, in optical communication switches. Some communication switches currently use LC pixels as the on/off modulators. The incorporation of the wavelength selection capability described herein, or the optical slit selectivity also described herein, could extend the switching capability.

The present invention provides for a plethora of sizes, shapes, configurations and uses of electrically selectable diffraction gratings or arrays that diffract white light and yield a selected color. FIG. 1 shows an embodiment that provides three different colors of light by energizing a single grating 18, 20, 21 and disconnecting the power to the other gratings, without the use of light filters.

FIG. 2 presents a further elaboration of the first embodiment by showing immersing of the grating 18, 20, 21 into an electrically active fluid 52 enclosed in a casing 48, with an opaque barrier 60 having an opening positioned above the casing. When energized, the chemicals in the fluid coat the electrodes 18.1-18.n, 20.1-20.n and 21.1-21.n so that the whole light 46 is diffracted and then selected by the angular position of the barrier opening with respect to the emitted wavelengths 54, 56, 58.

In order to reduce the loss of approximately ⅔ of the white light, another more efficient embodiment is presented in FIG. 4B. FIG. 4B passes white light 134 through an energized grating 136 for reflection 138(b) and 140 and selection 138(a) by a smooth 142(a) solid barrier 142 back down through the grating or array 136 and to a reflective device 146 for rediffraction in the grating and possible selection 140.

There are multitudes of variations to these various embodiments presented. FIG. 5B offers a side white light 148 that converts the grating 146 into a reflective device instead of a transmissive device. FIG. 6A uses a fixed diffraction grating with an opening or optical slit that is switchable 158.

FIG. 7 wires 72 a single grating 76 so that it alone could produce a limitless number of colors, based on the patterns and sequences of electrodes 18.1-18.n, 20.1-20.n and 21.1-21.n connected and energized.

Finally, FIG. 8 shows a novel TFT circuit with a common, source, common gate, and multiple drain outputs, each empowering a separate preselected ITO strip 18.1-18.n, 20.1-20.n and 21.1-21.n to produce any variety of colored light. This TFT may have other uses as well in unrelated devices where it is desired to switch on and off a multitude of circuits while disallowing shorting between them when off.

Referring now to FIG. 9 there is shown a schematic view of a display pixel 4A in accordance with another embodiment of the present invention. In this embodiment the pixel selectable diffraction gratings 18A, 20A, 21A are stacked one over the other. As seen in FIG. 9, this embodiment has three selectable diffraction gratings 18A, 20A, 21A, though in alternate embodiments any desirable number of gratings may be used. Diffraction gratings 18A, 20A, 21A are generally similar to the diffraction gratings 18, 20, 21 described before and shown in FIG. 1. In this embodiment however, the diffraction gratings 18A, 20A, 21A are positioned in vertical alignment with each other. Each grating 18A, 20A, 21A has a different sequence of electrode strips connected to a corresponding TFT 6A, 8A, 10A that controls the opacity of the electrode strips in each grating. When unenergized, the grating 18A, 20A, 21A is transparent to light so that light will pass through it unaltered or undiffracted. One grating 18A, 20A, 21A is energized based on a preselected sequence of electrodes to have a specific color of light. A light is emitted from source 2A into the lowest grating 18A and passes out from the top of the uppermost grating 21A, in the form of a desired color of light. The variety of color being selected according to the grating energized.

It should be understood that the foregoing description is only illustrative of the invention. Various alternatives and modifications can be devised by those skilled in the art without departing from the invention. Accordingly, the present invention is intended to embrace all such alternatives, modifications and variances that fall within the scope of the appended claims.

1. An electrical device, comprising:
a power source; and
a display connected to the power source, the display including optical elements, at least one of the optical elements comprising:
an electrically selectable diffraction grating.

2. The electrical device according to claim 1, wherein a light is positioned below the grating.

3. The electrical device according to claim 1, wherein the grating is comprised of electrode groups each containing n electrodes sequentially connected by conductive wiring to the power source to form a circuit.

4. The electrical device according to claim 3, wherein a first electrode group comprising n electrodes having every other electrode connected to the power source in a repeating sequence.

5. The electrical device according to claim 3, wherein a second electrode group comprising n electrodes having every other two electrodes connected to the power source in a repeating sequence.

6. The electrical device according to claim 3, wherein a third electrode group comprising n electrodes having every other three electrodes connected to the power source in a repeating sequence.

7. The electrical device according to claim 3, wherein the single grating contains a plurality of electrode groups containing n electrodes sequentially connected to the power source, a first electrode group comprising n electrodes with every other electrode being connected, a second electrode group comprising n electrodes with every other two electrodes being connected, and a third electrode group comprising n electrodes with every other three electrodes being connected.

8. The electrical device according to claim 1, wherein the electrodes are made of indium tin oxide.

9. The electrical device according to claim 1, wherein the electrodes are connected to a transistor.

10. An electrical device, comprising:
a power source; and
a display connected to the power source, the display including optical elements, at least one of the optical elements comprising:
at least two electrically selectable diffraction gratings.

11. The electrical device according to claim 10, wherein a light is positioned below the grating.

12. The electrical device according to claim 10, wherein one grating is comprised of electrodes in p sequence connected to the power source and another grating is comprised of electrodes in q sequence, further wherein the p sequence is dissimilar to the q sequence.

13. The electrical device according to claim 10, wherein the electrodes are connected to a transistor.

14. The electrical device according to claim 10, wherein the electrodes are indium tin oxide.

15. An electrical device, comprising:
a power source; and
a display connected to the power source, the display including optical elements, at least one of the optical elements comprising:
a liquid crystal display inside transparent casing; and
a solid barrier having an opening is positioned above the casing.

16. The electrical device according to claim 15, wherein a light source is positioned below the casing.

17. The electrical device according to claim 15, wherein the liquid crystal display is an electrically selectable diffraction grating, immersed in an electrically active fluid.

18. The electrical device according to claim 17, wherein the electrically active fluid is an electrochromic type cell.

19. The electrical device according to claim 18, wherein the electrochromic type cell is comprised of an electroplatable material that is reversible.

20. The electrical device according to claim 19, wherein the electroplatable metal salt in an electrolyte solution is comprised of bismuth chloride.

21. The electrical device according to claim 15, wherein the liquid crystal display is composed of a grating of electrodes immersed in bismuth chloride.

22. The electrical device according to claim 15, wherein the liquid crystal display is an in plane switching mode.

23. The electrical device according to claim 15, wherein the electrodes are connected to a transistor.

24. The electrical device according to claim 15, wherein the single grating contains a plurality of electrode groups containing n electrodes sequentially connected to the power source, a first electrode group comprising n electrodes with every other electrode being connected, a second electrode group comprising n electrodes with every other two electrodes being connected, and a third electrode group comprising n electrodes with every other three electrodes being connected.

25. The electrical device according to claim 15, wherein the electrodes are indium tin oxide.

26. The electrical device according to claim 15, wherein the solid barrier, the casing, and the light source are enclosed inside an outer casing including a side parallel to the solid barrier and a side parallel to the light source.

27. The electrical device according to claim 15, wherein the side parallel to the barrier being transparent.

28. The electrical device according to claim 15, wherein the casing is hermetically sealed.

29. An electronic display, comprising:
a power source and a light source;
a display connected to the power source, the display including an array of optical elements, at least one of the optical elements comprising:
an electrically selectable diffraction grating;
a smooth solid barrier with a reflective coating positioned above the grating, the barrier having an opening; and
the light source being positioned below the grating and above a reflective device positioned below the grating and below the light source.

30. The electrical display according to claim 29, wherein the grating is comprised of electrodes sequentially connected to the power source.

31. The electrical display according to claim 30, wherein the single grating contains a plurality of electrode groups containing n electrodes sequentially connected to the power source, a first electrode group comprising n electrodes with every other electrode being connected, a second electrode group comprising n electrodes every other two electrodes being connected, and a third electrode group comprising n electrodes every other three electrodes being connected.

32. The electrical display according to claim 29, wherein the electrodes are indium tin oxide.

33. The electrical display according to claim 29, wherein the electrodes are connected to a thin film transistor.

34. The electrical display according to claim 29, wherein the reflective coating is a mirror.

35. The electrical display according to claim 29, wherein the reflective device is a mirror.

36. A method of generating a color of light, comprising the steps of:
providing a power source and a light source;
forming an electrically selectable diffraction grating having a topside and a bottom side;
energizing the grating from the power source; and
emitting light with the light source into the bottom side of the grating the light being diffracted by the grating wherein, light with a predetermined color exits the topside of the grating.

37. The method according to claim 36, further comprising the step of: forming the grating by sequentially connecting the electrodes to the power source.

38. The method according to claim 37, wherein the single grating contains a plurality of electrode groups containing n electrodes sequentially connected to the power source, a first electrode group comprising n electrodes with every other electrode being connected, a second electrode group comprising n electrodes with every other two electrodes being connected, and a third electrode group comprising n electrodes with every other three electrodes being connected.

39. A method of generating a color of light, comprising the steps of:
providing a power source and a light source;
forming at least two electrically selectable diffraction gratings, each grating having a top side and a bottom side;
positioning the at least two electrically selectable diffraction gratings adjacent each other;
energizing only one of the gratings from the power source; and
emitting light from the light source into the bottom side of the lower grating, the light being diffracted depending on the grating energized, wherein, light with a predetermined color exits the top side of the energized gratings.

40. The method according to claim 39, further comprising the step of: forming the gratings by sequentially connecting the electrodes to a power source.

41. The method according to claim 40, wherein one grating is comprised of electrodes in p sequence connected to the power source and another grating is comprised of electrodes in q sequence, further wherein the p sequence is dissimilar to the q sequence.

42. A method of generating color in a color display, comprising the steps of:
providing a power source and a light source;
forming an electrically selectable diffraction grating inside a casing containing an electrically active fluid, the casing having a topside and a bottom side;
placing a solid barrier positioned above the casing the barrier having an opening;
energizing the grating from the power source; and
emitting light with the light source into the bottom side of the casing, the light exiting the topside of the casing as diffracted wavelengths for specific selection by the opening.

43. The method according to claim 42, further comprising the step of: forming the gratings by sequentially connecting the electrodes to a power source.

44. The electrical device according to claim 43, wherein the single grating contains a plurality of electrode groups containing n electrodes sequentially connected to the power source, a first electrode group comprising n electrodes with every other electrode being connected, a second electrode group comprising n electrodes with every other two electrodes being connected, and a third electrode group comprising n electrodes with every other three electrodes being connected.

45. A method of generating color from a color display, comprising the steps of:
providing the display with a light source and connecting the display to a power source;
forming an electrically selectable diffraction grating having a topside and a bottom side;
placing a smooth solid barrier with an opening, above the grating;
placing the light source below the grating;
placing a reflective device below the light source and the grating;
energizing the grating with the power source; and
emitting light from the light source into the bottom side of the grating wherein, a multitude of diffracted wavelengths exit the top of the grating for selection of a single wavelength by the opening and reflection of the unselected wavelengths down through the top side of the grating to the reflective device and back up through the bottom side of the grating for possible reselection.

46. The method according to claim 45, further comprising the step of: forming the grating by sequentially connecting the electrodes to a power source.

47. The method according to claim 46, further comprising the step of: forming a single grating to contain a plurality of electrode groups containing n electrodes sequentially connected to the power source, a first electrode group comprising n electrodes with every other electrode being connected, a second electrode group comprising every other two electrodes being connected, and a third electrode group comprising every other three electrodes being connected.
